(19) United States
(12) Patent Application Publication
(10) Pub. No.: US 2010/0131428 A1
(43) Pub. Date: May 27, 2010

(54) SYSTEM AND METHOD FOR PERSONALIZED PRICE/FILE SIZE PER SCAN

(75) Inventor: Ramesh Nagarajan, Pittsford, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/276,912

(22) Filed: Nov. 24, 2008

(51) Int. Cl. G06Q 30/00; G06K 9/00

(52) U.S. Cl. 705/400; 382/112

(57) ABSTRACT

A method of determining a quality of a file of a scanned page based upon a user selected input including examining the content of the scanned page via detecting at least one object on the scanned page, classifying each object on the scanned page and estimating a file size of each object on the scanned page. A file size of the scanned page is approximated based upon the estimated file size of each object on the scanned page. A user input for the scanned page is received and compared to the approximated file size of the scanned page. Finally, a file is generated from the scanned page wherein the quality of the file is based upon the comparison between the user selected input and the approximated file size of the scanned page.

### CROSS-REFERENCE TO A RELATED PATENT APPLICATION

This application is related to an application filed on Jul. 2, 2008 and assigned U.S. application Ser. No. 12/166,874 and titled “SYSTEM AND METHOD FOR PERSONALIZED PRICE PER PRINT/COPY”, the entire contents of which are incorporated herein by reference.

### BACKGROUND

1. Technical Field

The present disclosure relates to scanning costs, and, in particular, to a system and method for controlling scanning in which the quality and file size of the scan are adjusted to match the price or file size desired by the user.

2. Description of Related Art

In order to scan a document at a specific cost or file size, users today have to make several imaging and quality selections in order to reach the desired price or file size. Users generally have to use a trial and error process working through multiple tabs to adjust the scan settings to reach the desired price or file size. Manual scan controls which affect file size, and thus cost, include, but are not limited to, image options, image enhancements, file formats, scan presets, quality and resolution. A user can reduce the file size of a scan by manually altering color, original type, subtype selection, saturation, lighter/darker contrast, and auto background suppression selections.

The difficult trial and error process of adjusting multiple scan controls in order to reach a desired cost or file size has lead to charging for scanning based upon printing/copying modes, i.e. the user may choose either a black and white or a color scan. This approach involves charging a “per click” fee of a fixed amount when a user scans a black and white page, and charging a different amount for the “per click” fee when scanning a color page. This is referred to as the “one size fits all billing approach” and is simply billing one fee for scanned black and white pages and another fee for scanned color pages, regardless of the content in the scanned page. For example, the “per click” fee may be $0.01 (U.S) per black and white printed page and $0.08 (U.S.) per color printed page.

Another approach is to determine the cost of the scan based upon the activity of a scanner or output hardware. U.S. Pat. No. 6,112,039 discloses a billing-for-scanning system which includes an audit system for determining how much credit a particular user has to expend on a particular function. For example, if a user requests fifty scans or prints, the audit system will, before processing each image, determine if the particular user has enough credit to pay for the output image. The pricing of a particular job may be determined by the counts of activities of the scanner or output hardware.

The prior art does not generally take into account the objects that are in the page or how those objects are distributed in the page. For example, there are several types of black and white and/or color objects that may be on any page. Some of the types of objects are: monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, and color solid fill objects. The presence or absence of these objects affects the file size of a scan and thus the price of the scan.

### SUMMARY

In accordance with the present disclosure, a method of determining a quality of a file of a scanned page based upon a user selected input is provided. The first step in the method comprises examining the content of the scanned page includes the steps of detecting at least one object on the scanned page, classifying each object on the scanned page and estimating a file size of each object on the scanned page. A file size of the scanned page is then approximated based upon the estimated file size of each object on the scanned page. A user selected input is received and compared to the approximated file size of the scanned page. Finally, a file is generated from the scanned page wherein the quality of the file is based upon the comparison between the user selected input and the approximated file size of the scanned page.

In one embodiment of the present disclosure, the detecting step comprises a micro-detection step and a macro-detection step. The classifying step may include classifying each object as a particular type of object selected from the group consisting of a monochrome contone object, a color contone object, a monochrome text object, a color text object, a monochrome line art object, a color line art object, a monochrome graphic object, a color graphic object, a monochrome low frequency halftone object, a color low frequency halftone object, a monochrome high frequency halftone object, a color high frequency halftone object, a monochrome solid fill object and a color solid fill object.

The user selected input may be a price a user is willing to pay for the scanned page or a file size a user is willing to allocate to the scanned page. If the user selected input is a price the user is willing to pay, the price may be selected from at least one of a minimum price, a maximum price, and a default price. The file generated may be generated in black and white if the user selected input is the minimum price or may be generated in full color with highest quality (e.g. 600 dpi High Quality JPEG compressed) if the user selected input is the maximum price. If the user selected input is a file size the user is willing to allocate to the scanned page, the file size may be selected from at least one of a minimum file size, a maximum file size, and a default file size. The file generated may be generated in black and white if the specific user selected input is the minimum file size or may be generated in full color with highest quality if the specific user selected input is the maximum file size.

In another embodiment of the present disclosure, the method further comprises the step of adjusting at least one quality parameter of the scanned page based upon the comparison between the user selected input and the approximated file size of the scanned page. The quality parameters may be selected from the group consisting of saturation, brightness, contrast, background suppression, color, tint, and resolution. The method may also include the step of selecting the file format of the scanned page based upon the comparison between the user selected input and the approximated file size of the scanned page. The file format may be selected from the group consisting of PDF, PDF/A, XPS, multi-page TIFF, TIFF, and JPEG.

In accordance with yet another embodiment of the present disclosure, a method of determining a quality of a file of a scanned page based upon a user selected input is provided. The content of the scanned page is examined; this entails detecting at least one object on the scanned page, classifying each object on the scanned page and estimating a file size of each object on the scanned page. A file size of the scanned page is then approximated based upon the estimated file size of each object on the scanned page. A user selected input is received and converted into a target file size for the scanned page. The target file size is compared to the approximated file size of the scanned page and at least one quality parameter of the scanned page is adjusted if the approximated file size of the scanned page is not less than the target file size. The at least one quality parameter may be selected from the group consisting of saturation, brightness, contrast, background suppression, color, tint and resolution.

If the approximated file size is still not less than the target file size, the file format of the scanned page may be changed. The file format may be selected from the group consisting of PDF, PDF/A, XPS, multi-page TIFF, TIFF, and JPEG.

The quality and/or default file format of the scanned page may be maintained if the approximated file size is less than the target file size.

In one embodiment, the user selected input may be a price a user is willing to pay for the scanned page wherein that price converted into the target file size. Alternatively, the user selected input may be a file size a user is willing to allocate to the scanned file, wherein that file size is the target file size.

In another embodiment, a computer-readable medium is provided which stores programmable instructions configured for being executed by at least one processor for performing the methods described herein according to the present disclosure. The computer-readable medium can include flash memory, CD-ROM, a hard drive, etc.

### BRIEF DESCRIPTION OF THE DRAWINGS

These and other advantages will become more apparent from the following detailed description of the various embodiments of the present disclosure with reference to the drawings wherein:

FIGS. 1A and 1B are graphic representations of pages with objects on the pages in accordance with the present disclosure;

FIGS. 2A-B are user interfaces in accordance with embodiments of the present disclosure; and

FIG. 3 is a block diagram illustrating a method for altering the quality of a page based on a user selected input.

### DETAILED DESCRIPTION

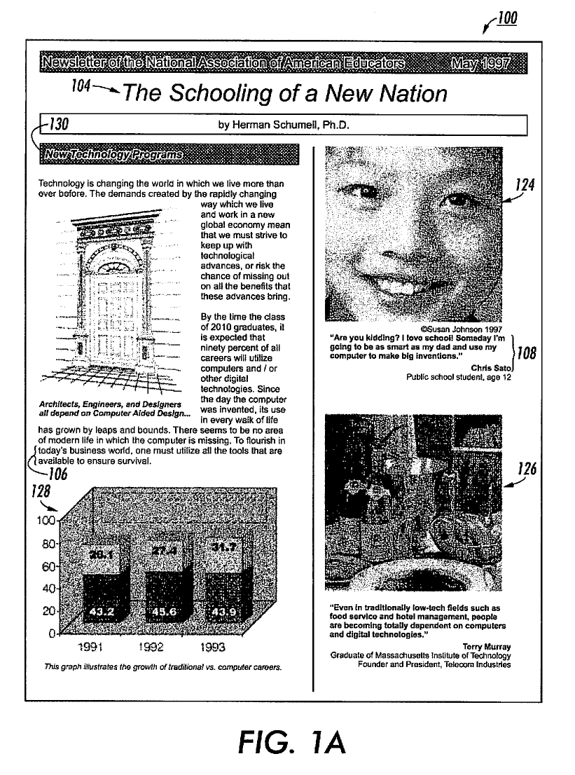

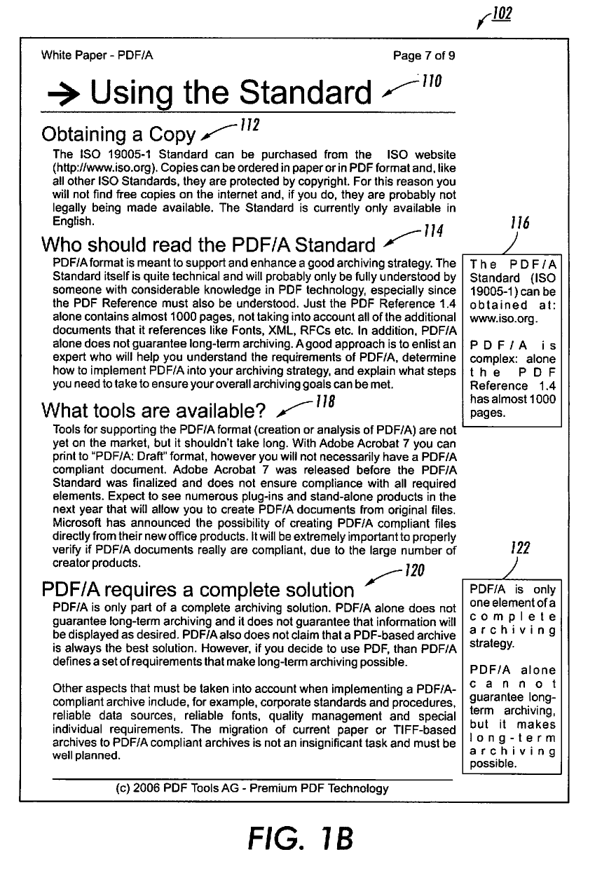

FIGS. 1A and 1B show pages 100 and 102, respectively. Page 100 includes color text objects 104, 106, 108, color high frequency halftone objects 124 and 126, color graphic object 128, and color line art object 130. Page 102 includes color text objects 110, 112, 114, 116, 118, 120, and 122. The types of objects that may be included in a page are: monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, and/or color solid fill objects.

A page can take many forms, e.g., pages 100 and 102. A page may be a scanned page, an image of a page, a page description language page, a printed page, a copied page, a computer-memory based page, a hard-drive based page, a raster page, a vector graphics page, or the like. Additionally or alternatively, pages 100 and 102 may be a representation of a page in printed form (e.g., printed pages).

Prior art systems have only two mutually exclusive modes for scanning page content. The prior art systems either scan color pages in “full color” or in “monochrome only”. In the full color mode, all of the color objects in the page are scanned into a file “as-is.” In the monochrome only mode, all of the color objects are converted to monochrome objects before (or simultaneously with) the production of the scanned page file.

These two methods of the prior art systems may be used in conjunction with any scanning technology. Referring to FIGS. 1A and 1B, pages 100 and 102 may be scanned using the prior art systems. However, many entities involved in the color scanning industry bill the costs of scanning a page based on which mode (i.e., full color or monochrome only) is utilized to scan the page regardless of the content of the page (e.g., types of objects on the page). By way of example, using the prior art systems, pages 100 and 102 would be billed at the same rate when scanned using the full color mode despite page 100 including significantly more complex color objects relative to page 102.

Because of the significant file size and thus price difference between scanning pages using the full color mode versus using the monochrome only mode, many system administrators prevent users from scanning in color or restrict their use. Scanning color pages generally has an increased file size per page as compared to scanning monochrome pages and also has an increased file size per page compared to monochrome pages. However, different types of color objects have different effects on the aggregate file size. For example, scanning a page having color text with the remainder of the page being in monochrome does not generally incur additional storage space as compared to scanning a page in monochrome only. Additionally, color text objects require a smaller file size as compared to color graphic objects or color high or low frequency halftone objects. Furthermore, scanning a color object with fewer colors reduces the file size of the scan as compared to scanning the object in full color.

With continued reference to FIGS. 1A and 1B and as mentioned above, page 100 includes color text objects 104, 106, 108, color high frequency halftone objects 124 and 126, color graphic object 128, and color line art object 130; while page 102 includes color text objects 110, 112, 114, 116, 118, 120, and 122. Despite pages 100 and 102 both being in color, the color high frequency halftone objects 124 and 126, color graphic object 128, and color line art object 130 would require a greater file size when scanned than would the color text objects of page 102. Thus, assuming similar quality settings, the file size of scanned page 100 would generally be greater than the file size of scanned page 102.

In the prior art method discussed above, pages 100 and 102 would be billed on a “per click” fee resulting in the two pages being billed at about the same fee when scanned, or at exactly the same fee. However, what the prior art method fails to account for is the correlation of the file size associated with a particular scanned page to the page content (e.g., the objects in the page). For example, a 1×1 inch object on a scanned page may require a relatively large file size if the object were a color high frequency halftone object as compared to a color low frequency halftone object or a color line art object. The reasons for the additional file size may be at least partially due to the bit depth of each object or the dots per inch (DPI). Bit depth refers to the number of bits required to store information about each dot (or pixel). For example, black and white objects only have one bit of data associated with each dot. The dot is either black or white. For 256 color objects, there are 8 bits of data associated with each dot. The more bits of data required for each dot, the larger the file size of that object. DPI, on the other hand, is a measure of the number of physical dots associated with an object. A higher DPI increases the file size. Thus, the file size of any image object is at least partially related to the number of dots (pixels) making up the object and the number of bits required to store information of each dot. The bit depth and DPI may differ significantly between the different types of objects listed above, and thus the file size of the objects listed above may also differ significantly.

Since the bit depth and DPI, and thus the file size of various objects is related to the type of object, it is important to detect, separate and classify the various objects on a particular page. An auto-windowing technique is described in commonly owned U.S. Pat. No. 5,850,474 and U.S. Pat. No. 6,240,205, the entire contents of both of which are incorporated herein by reference. Using an auto-windowing or similar technique, the content of the scanned page may be examined and image data on the scanned page may be detected. The detecting step may include a micro-detection step, wherein each pixel on the page is examined and a preliminary determination is made as to the image type of the pixel, and a macro-detection step, wherein the results of the micro-detection step are used to determine which pixels determine the edge of the image and which pixels belong to image. The image data may then be separated into at least one window. The image data within each window is then classified as a particular type of image data. Using this auto-windowing and MRC segmentation described in U.S. Pat. No. 5,850,474 and U.S. Pat. No. 6,240,205, one can differentiate text and line art content from windowed objects by detecting image objects on the page, windowing similar objects and classifying those objects as a particular type of object. Simple file estimation of each mask and image object can then be performed and aggregated to approximate the overall file size of the scanned page.

Using the above described method of file size estimation, customers are provided scanning options that allow color documents to be scanned at a lower price. For example, a scan mode may be offered (e.g., via a user interface) to provide the user with the option of scanning text and line art in color with the remainder of the content (e.g., color graphic objects) scanned in black and white. This provides the user with a customizable billing option for scanning services.

The present disclosure provides users with additional customizable options for scanning services to satisfy varying user demands. More specifically, the present disclosure provides a method of determining a quality output of a page based on a user selected input. The user selected input may be a price. That is, the user may select a price per page that the user is willing to pay for a specific scan job as an input (e.g., via a user interface) and the quality of the page is an output based on the user selected price. Alternatively, the user selected input may be a file size. In this situation, the user may select a file size per page that the use is willing to allocate for a specific scan job as an input and the quality of the page is an output based on the user selected file size.

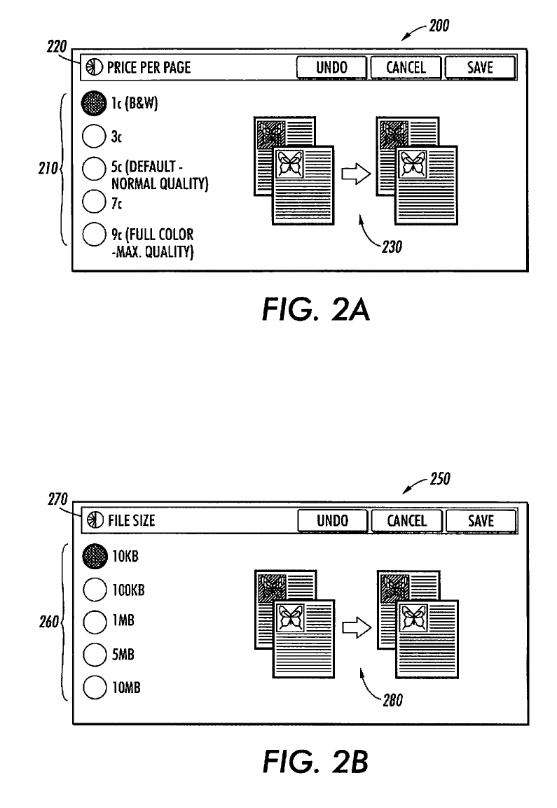

Referring to FIGS. 2A-B, two user interfaces 200, 250 are shown for use with the present disclosure. User interfaces 200, 250 are simply two embodiments which may be used in connection with the present disclosure. Either of user interfaces 200, 250 may be implemented using any suitable processing and/or computing device and graphically displayed via a display (e.g., touch-screen and/or LCD, etc.) onboard one or more scanning devices (not explicitly shown) and/or in operative communication therewith.

User interface 200 includes a price selection interface 210, a main interface 220, and a display interface 230. The price selection interface 210 provides the user with a plurality of pricing options from which to select, including a minimum and maximum price. The minimum price (e.g., U.S. $0.01) may be selected to generate a file in black and white only (e.g., devoid of color) and the maximum price (e.g., U.S. $0.09) may be selected to generate a file in full color. Further, a default price (e.g., $0.05) may be selected to generate a file with predetermined quality parameters (e.g., saturation, brightness, contrast, background suppression, etc.). The price selection interface 210 may include a plurality of prices (e.g., U.S. $0.03, U.S. $0.07, etc.) ranging between the minimum and maximum prices to provide the customer with various options for altering the quality parameters of a page. Quality parameters of a scanned page may be, for example, saturation, brightness, contrast, tint, color, background suppression, resolution, etc. Other quality parameters may be included and the above list should not be construed as exhaustive. In addition to adjustment of quality parameters, the file format of the scanned page may also be altered, thereby affecting the quality and the file size of the scanned page. File formats may include, but are not limited to PDF, PDF/A, XPS, multi-page TIFF, TIFF, and JPEG.

The pricing options depicted in FIG. 2A are illustrative only and other price designations are contemplated. For example, the price range may be customizable according to the market region in which the method of the present disclosure is being implemented.

User interface 250, shown in FIG. 2B includes a file size selection interface 260, a main interface 270, and a display interface 280. User interface 250 is substantially similar to user interface 200 except that the file size selection interface 260 provides the user with a plurality of file size options from which to select, rather than pricing options. File size selection interface 260 may include a plurality of file sizes (e.g., from 10 KB to 10 MB) to provide the customer with various options for altering the quality parameters of a file. The quality and file size of the scanned page may further be altered by changing the file format of the scanned page. The file formats may include those listed above, but are not limited to those. The file size options depicted in FIG. 2B are illustrative only and other file size designations are contemplated.

Once a price or file size is selected by the user via either price selection interface 210 or file size selection interface 260, respectively, the applicable display interface 230, 280 displays an image of the page having quality parameters in accordance with the price or file size selected by the user. In the embodiment of FIG. 2A, display interface 230 displays a first image of the page having the default quality parameters and a second image of the page having the quality parameters based on the price selected by the user. Display interface 280, in the embodiment of FIG. 2B, is substantially similar to that of display interface 230, displaying a first image having the default quality parameters and a second image having the quality parameters based on the user selected file size. In this manner, the user may view the difference between image qualities and, thus, vary the price or file size selection accordingly. Further, the user interfaces 200, 250 may display a suitable message (e.g., text, graphical, etc.) to warn the user of the potential loss of quality based on the price or file size selected.

The main interface 220 or 270 is configured to permit the user to finalize a price or file size selection (e.g., via a “save” link), undo or deselect a price or file size selection (e.g., via an “undo” link), and/or cancel out of the user interface (e.g., via a “cancel” link) to access other interfaces of a scanning device. The main interface 220 or 270 may also include user login information (e.g., username) to identify the user to be billed for the scan job.

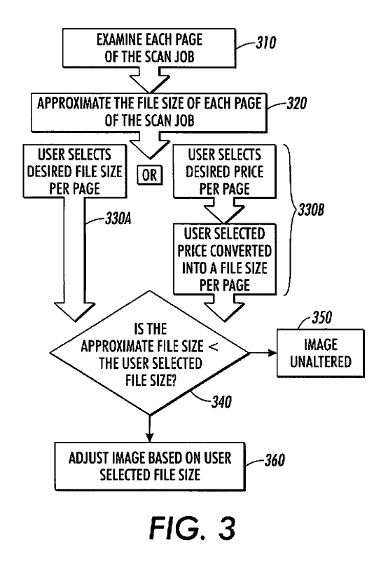

FIG. 3 is a flow chart diagram illustrating a method of providing scanning service based on a user-selected file size or price. The method may be implemented using software executable instructions. More specifically, the method may be executed through use of a suitable processing module (not explicitly shown) in operative communication with the scanning device that is generating the job. The processing module may include a memory configured to store software instructions and a processor configured to execute the software instructions stored in the memory.

In step 310, the content of each page of the scan job is examined. More specifically, one or more objects on the page are detected and the one or more objects are classified. Based on the classification of each object and the size of that object relative to the page, an estimation of the file size of each object is made. In step 320, the file size estimations of each object on the page are aggregated to form a total approximated file size of the page. Step 330 is split into sub-steps 330A and 330B, depending on which selection interface is used. If price selection interface 210 (e.g., the embodiment of FIG. 2A) is used, step 330B will apply and the user selects a price per page the user is willing to pay, that price per page being converted into a target file size per page. If file size selection interface 260 (e.g., the embodiment of FIG. 2B) is used, step 330A will apply.

In step 330A, the user, through use of the file size selection interface 260, selects the desired file size per page. Before the completion of step 330, the user has the option to undo or deselect the file size or price options via the main interfaces 220, 270 and subsequently reselect a price or file size option via the selection interfaces 210, 260. That is, step 330 may be repeated in accordance with the user's interaction with the selection interfaces 210, 260. As mentioned above, if the user selects a price (e.g., the price selection interface 210 is used), the price is then converted into a target file size for comparison to the approximated file size of the page. If the user selects a file size, that selected file size becomes the target file size for comparison with the approximated file size.

Once the user commits to a price or file size per page and subsequently opts to finalize the price or file size selection (e.g., via the “save” link of the main interface 220 or 270), in step 340, the target file size is processed (e.g., via the processing module) and compared to the approximated file size of the page determined in step 320. If the approximated file size of the page is less than the target file size, the quality parameters of the page are unaltered in step 350. If the approximated file size per page is not less than the target file size, the quality parameters of the page are altered in accordance with the target file size in step 360. In this scenario, the quality parameters of the page are altered such that the approximated file size of the page will be at most equivalent to, but not more than, the target file size desired by the user. The quality adjustments may first be made to the quality parameters listed above; however, as mentioned above, the file format may also be changed in order to bring the approximated file size of the page in accordance with the target file size.

In another embodiment according to the present disclosure, a computer-readable medium is provided which stores programmable instructions configured for being executed by at least one processor for performing the methods described herein above according to the present disclosure. The computer-readable medium can include flash memory, CD-ROM, a hard drive, etc.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of determining a quality of a file of a scanned page based upon a user selected input, comprising:
examining the content of the scanned page comprising:
detecting at least one object on the scanned page;
classifying each object on the scanned page; and
estimating a file size of each object on the scanned page;
approximating a file size of the scanned page based upon the estimated file size of each object on the scanned page;
receiving a user selected input for the scanned page;
comparing the user selected input to the approximated file size of the scanned page;
generating a file from the scanned page wherein the quality of the file is based upon the comparison between the user selected input and the approximated file size of the scanned page.

2. The method of claim 1, wherein the detecting step comprises a micro-detection step and a macro-detection step.

3. The method of claim 1, wherein each object is classified as a particular type of object selected from the group consisting of:
a monochrome contone object,
a color contone object,
a monochrome text object,
a color text object,
a monochrome line art object,
a color line art object,
a monochrome graphic object,
a color graphic object,
a monochrome low frequency halftone object,
a color low frequency halftone object,
a monochrome high frequency halftone object,
a color high frequency halftone object,
a monochrome solid fill object, and
a color solid fill object.

4. The method of claim 1, wherein the user selected input is a price a user is willing to pay for the scanned page.

5. The method of claim 4, wherein the price is selected from at least one of a minimum price, a maximum price, and a default price.

6. The method of claim 5, wherein the file generated is generated in black and white if the user selected input is the minimum price.

7. The method of claim 5, wherein the file generated is generated in full color with highest quality if the user selected input is the maximum price.

8. The method of claim 1, wherein the user selected input is a file size a user is willing to allocate to the scanned page.

9. The method of claim 8, wherein the file size is selected from at least one of a minimum file size, a maximum file size, and a default file size.

10. The method of claim 9, wherein the file generated is generated in black and white if the specific user selected input is the minimum file size.

11. The method of claim 9, wherein the file generated is generated in full color if the specific user selected input is the maximum file size.

12. The method of claim 1, further comprising the step of adjusting at least one quality parameter of the scanned page based upon the comparison between the user selected input and the approximated file size of the scanned page.

13. The method of claim 12, wherein the at least one quality parameter is selected from the group consisting of:
saturation,
brightness,
contrast,
background suppression,
color,
tint, and
resolution.

14. The method of claim 1, further comprising the step of selecting the file format of the scanned page based upon the comparison between the user selected input and the approximated file size of the scanned page.

15. The method of claim 6, wherein the file format is selected from the group consisting of:
PDF,
PDF/A,
XPS,
multi-page TIFF,
TIFF, and
JPEG.

16. A method of determining a quality of a file of a scanned page based upon a user selected input, comprising:
examining the content of the scanned page comprising:
detecting at least one object on the scanned page;
classifying each object on the scanned page; and
estimating a file size of each object on the scanned page;
approximating a file size of the scanned page based upon the estimated file size of each object on the scanned page;
receiving a user selected input for the scanned page;
converting the user selected input into a target file size for the scanned page;
comparing the target file size to the approximated file size of the scanned page; and
adjusting at least one quality parameter of the scanned page if the approximated file size of the scanned page is not less than the target file size.

17. The method of claim 16, wherein the at least one quality parameter is selected from the group consisting of:
saturation,
brightness,
contrast,
background suppression,
color,
tint, and
resolution

18. The method of claim 16 further comprising the step of changing the file format of the scanned page if the approximated file size is still not less than the target file size.

19. The method of claim 18, wherein the file format is selected from the group consisting of:
PDF,
PDF/A,
XPS,
multi-page TIFF,
TIFF, and
JPEG.

20. The method of claim 16, further comprising the step of maintaining the quality of the page if the approximated file size is less than the target file size.

21. The method of claim 16, wherein the user selected input is a price a user is willing to pay for the scanned page and wherein the price is converted into the target file size.

22. The method of claim 16, wherein the user selected input is a file size a user is willing to allocate to the scanned file and wherein the user selected file size is the target file size.

23. A computer-readable medium storing programmable instructions configured for being executed by at least one processor for performing a method of determining a quality of a file of a scanned page based upon a user selected input, the method comprising:
examining the content of the scanned page comprising:
detecting at least one object on the scanned page;
classifying each object on the scanned page; and
estimating a file size of each object on the scanned page;
approximating a file size of the scanned page based upon the estimated file size of each object on the scanned page;
receiving a user selected input for the scanned page;
comparing the user selected input to the approximated file size of the scanned page;
generating a file from the scanned page wherein the quality of the file is based upon the comparison between the user selected input and the approximated file size of the scanned page.

24. A computer-readable medium storing programmable instructions configured for being executed by at least one processor for performing a method of determining a quality of a file of a scanned page based upon a user selected input, the method comprising:
examining the content of the scanned page comprising:
detecting at least one object on the scanned page;
classifying each object on the scanned page; and
estimating a file size of each object on the scanned page;
approximating a file size of the scanned page based upon the estimated file size of each object on the scanned page;
receiving a user selected input for the scanned page;
converting the user selected input into a target file size for the scanned page;
comparing the target file size to the approximated file size of the scanned page; and
adjusting at least one quality parameter of the scanned page if the approximated file size of the scanned page is not less than the target file size.
